(19) United States
(12) Patent Application Publication
(10) Pub. No.: US 2012/0119001 A1
(43) Pub. Date: May 17, 2012

(54) ENVIRONMENTAL CONTAMINATION INHIBITION

(75) Inventor: Takahisa Kusuura, Kawasaki-shi (JP)

(73) Assignee: EMPIRE TECHNOLOGY DEVELOPMENT LLC, Wilmington, DE (US)

(21) Appl. No.: 13/125,299

(22) PCT Filed: Nov. 11, 2010
(86) PCT No.: PCT/US10/56302

§ 371 Date: Apr. 20, 2011

(51) Int. Cl. B02C 21/00; B09B 3/00; B05B 1/00

(52) U.S. Cl. 241/21; 239/589; 588/249

(57) ABSTRACT

A system for reducing environmental contamination from structure demolition can include a fluid first aqueous composition having an alginic acid or alginate dissolved in water, and a fluid second aqueous composition having a calcium salt dissolved in water. The system can be used in a method for reducing environmental contamination from structure demolition. The method can be conducted by: applying the first aqueous composition to a structure to be demolished; applying the second aqueous composition to the first composition on the structure such that the alginic acid or alginate undergoes gelation into a gel; and demolishing the structure such that the gel captures particles and inhibits environmental contamination from the particles.

### BACKGROUND

Construction and demolition sites can produce a number of environmental contaminants ranging from organic substances to heavy metals. Environmental contaminants can be released when building materials are handled and transported around a construction site. Demolition can release environmental contaminants when structures contain environmental contaminants. The release of environmental contaminants can be particular or liquid in nature. Particulate and liquid environmental contaminants can pollute air, soil, and can end up in water resources where they can be further distributed to pollute the environment.

Also, there is growing concern over chipping work at construction sites, and the release of airborne particles at demolition sites, namely asbestos and the glass fiber contained in fiber-reinforced polymers (FRP). Furthermore, there are also serious concerns over the fact that demolition of structures at university and corporation laboratories, and plants, can result in the release of harmful substances (e.g., heavy metals, organic substances, and bacteria), which build up on associated equipment and piping, leading to soil and groundwater pollution.

A common protocol for reducing such environmental contaminants includes sprinkling water to prevent dust and particulates from becoming airborne. However, the use of water can have an unwanted side effect by carrying the contaminants into soil and waterways. Additionally, use of a valuable resource such as water is unfavorable because the water becomes polluted from the environmental contaminants which can exacerbate the environmental impact. Also, the use of large quantities of water is not favorable in arid climates. Moreover, the water can collect the contaminants and drain and/or pool to deteriorate the working environment into a slippery, muddy, and dangerous area.

Previously, agents such as gum arabic or carboxymethylcelluloses have been used to prevent asbestos particles from becoming airborne. However, such agents tend to dry quickly and then themselves become susceptible to being particulates that contain environmental contaminants.

### SUMMARY

In one embodiment, a system for reducing environmental contamination from structure demolition can include: a fluid first aqueous composition having an alginic acid or alginate dissolved in water; and a fluid second aqueous composition having a calcium salt dissolved in water

In one embodiment, a method for reducing environmental contamination from structure demolition can include providing a system as described herein; applying the first aqueous composition to a structure to be demolished; applying the second aqueous composition to the first composition on the structure such that the alginic acid or alginate undergoes gelation into a gel; and demolishing the structure such that the gel captures particles and inhibits environmental contamination from the particles.

In one embodiment, another method for reducing environmental contamination from structure demolition can include: providing a fluid aqueous composition having an alginic acid or alginate dissolved in water; combining ionized calcium to the alginic acid or alginate; applying the aqueous composition to a structure to be demolished such that the alginic acid or alginate undergoes gelation into a gel; and demolishing the structure such that the gel captures particles and inhibits environmental contamination from the particles. In one embodiment, yet another method for reducing environmental contamination from structure demolition can include: providing a system as described herein; applying the first aqueous composition to a structure to be demolished; applying the second aqueous composition to soil around structure; and demolishing the structure such that first aqueous composition contacts the second aqueous composition and gels captures particles and inhibits environmental contamination from the particles. The gel is capable of capturing dust, solid, and liquid contaminants. Aspects of other method embodiments can also be performed with regard to this method embodiment.

In one embodiment, another method for reducing environmental contamination from structure demolition can include: providing a system as described herein; applying the first aqueous composition to a demolition site; and applying the second aqueous composition to the first composition on the demolition site such that the alginic acid or alginate undergoes gelation into a gel that captures particles and inhibits environmental contamination from the particles. Aspects of other method embodiments can also be performed with regard to this method embodiment.

In one embodiment, another method for reducing environmental contamination from structure demolition can include: providing a system as described herein; applying the first aqueous composition to demolition site; applying the second aqueous composition to the first composition on the demolition site such that the alginic acid or alginate undergoes gelation into a gel that captures particles and inhibits environmental contamination from the particles. Aspects of other method embodiments can also be performed with regard to this method embodiment.

In one embodiment, another method for reducing environmental contamination from structure demolition can include: providing a system as described herein; applying the first aqueous composition to contaminants; and applying the second aqueous composition to the first composition on the contaminants such that the alginic acid or alginate undergoes gelation into a gel that captures the contaminants and inhibits environmental contamination from the contaminants. Aspects of other method embodiments can also be performed with regard to this method embodiment.

In one embodiment, another method for reducing environmental contamination from structure demolition can include: providing a system as described herein; applying the first aqueous composition to contaminants; applying the second aqueous composition to the first composition on the contaminants such that the alginic acid or alginate undergoes gelation into a gel that captures the contaminants and inhibits environmental contamination from the contaminants. Aspects of other method embodiments can also be performed with regard to this method embodiment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1A-1B show schematic representations of illustrative embodiments of a system for reducing environmental contamination from structure demolition.

FIG. 2 shows a schematic representation of an illustrative embodiment of a system for reducing environmental contamination from structure demolition.

FIG. 3 shows a schematic representation of an illustrative embodiment of a system for reducing environmental contamination from structure demolition.

FIG. 4 shows a schematic representation of an illustrative embodiment of a process for reducing environmental contamination from structure demolition.

FIG. 5 shows a schematic representation of an illustrative embodiment of a process for reducing environmental contamination from structure demolition.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Generally, a gelatinous coating material can be prepared and coated onto structures, where the gelatinous coating material can prevent release of contaminants that are generated as a result of demolishing the structure. The gelatinous coating material can capture and retain particulates, dust, and other small debris in order to prevent these contaminants from becoming airborne. Also, the gelatinous coating material can capture and retain solid and liquid contaminants that contact the ground in order to inhibit the contaminants from contaminating the ground or contaminating water.

Additionally, the gelatinous coating can be used for various aspects of construction. There are various construction activities that also pose the problem of releasing environmental contaminants for which the gelatinous coating can be used to inhibit the release of environmental contaminants in a similar way as described with respect to demolition of structures. As such, the discussion of structure demolition and embodiments of the gelatinous coating, compositions, systems, and methods may also refer to construction of structures. Thus, the gelatinous coating, compositions, systems and method may be used for construction processes that also may release environmental contaminants, and reference to structure demolition may include construction for simplicity.

The gelatinous coating material can be prepared by combining an alginic substance (e.g., alginic acid and/or alginate) with a calcium salt or ionized calcium. The alginate can include an alginate salt having a counter ion with a +1 or +2 charge. The counter ion can include sodium or calcium, where an alginic composition includes more sodium than calcium counter ion. The alginic composition can include a calcium alginate, where the calcium alginate is present in an amount less than sodium alginate. After combining the alginic substance and a sufficient amount of calcium, gelation is spontaneous. The alginic substance can be included in a high viscosity liquid that also includes a small amount of calcium salt such that the composition having the alginic substance is capable of sticking to vertical walls, and can exhibit thixotropy.

The gelatinous coating can be obtained by spraying an alginic substance on a structure to be demolished, and then spraying a calcium salt solution (e.g., aqueous) onto the alginic substance to induce gelation. The structure surface is subjected to irreversible gelation, and the structure surface can be covered to retain moisture during the gelation. Also, the structure on a demolition site, together with the demolition waste, and the ground can receive the gelatinous coating. The gelatinous coating can be covered with a water-impermeable covering to keep it moist over an extended period of time.

Additionally, a calcium salt solution can be applied to the ground or other structures at a demolition site. When the gelatinous coating or non-gelled alginic substance contacts the calcium salt on the ground or structure, moisture may be maintained or more gelation can occur. The calcium salt solution can be applied to the ground and structures before, during, and after demolition. The gelatinous coating can then capture and retain contaminants to keep them from spreading from the demolition site and into the ground or waterways.

A composition having the alginic substance can be referred to herein as “Solution A” or a “first aqueous composition.” The composition having the alginic substance can be prepared to have a low or high viscosity depending on the application. Low viscosity can be useful on horizontal surfaces, while high viscosity can be useful for vertical surfaces. Medium viscosity can be useful for surfaces that vary from horizontal to vertical. Of course, the high viscosity composition can be useful for any surface. The viscosity can be varied by the amount of alginic substance as well as the amount of calcium ions present in the composition. Viscosity is described at about 25° C. or at ambient conditions. Low viscosity composition can have a viscosity that ranges from about 0.05 cp to about 50 cp, from about 0.8 cp to about 25 cp, or about 0.1 cp to about 10 cp. Medium viscosity composition can have a viscosity that ranges from about 50 cp to about 200 cp, from about 75 cp to about 150 cp, or about 100 cp to about 125 cp. High viscosity composition can have a viscosity that ranges from about 200 cp to about 1000 cp, from about 300 cp to about 800 cp, or about 400 cp to about 600 cp.

The composition having the alginic substance can be prepared to be a viscous thixotropic liquid by dissolving alginic acid and a small amount of calcium salt in water. The viscosity can be modified by modulating the amounts and/or relative amounts of these two components. Alginate or alginic acid exhibits thixotropy when it contains a small amount of calcium salt (calcium alginate), achieving both good coating and contaminant retention qualities. Alginate or alginic acid is gelated by reaction with calcium salt, and as a result it becomes more stabilized. When specific amounts of sodium alginate and calcium alginate are mixed together, the resulting solution is a thixotropic non-Newtonian fluid. Sodium alginate is utilized as a thickener in food additives and is considered to be safe. When a small amount of sodium alginate is dissolved in water (with a concentration of several percent), it becomes a viscous liquid. Alginic substances are safe, have low environmental load (is biodegradable), and is readily available. Gum arabic or other types of adhesive may be added to enhance adhesion as necessary. It is also possible to add surfactant to cause foaming to an appropriate degree.

A composition having ionized calcium, such as a calcium salt, can be referred to herein as “Solution B” or a “second aqueous composition.” The composition having ionized calcium can be prepared by dissolving any calcium salt, as well as a small amount calcium alginate, in water. When the composition having ionized calcium is combined with a composition having an alginic substance, a gel can be formed as described herein.

Due to thixotropic properties of Solution A and the resulting gel, both good coating and retention qualities can be achieved for construction/demolition activities that release contaminants. The evaporation of moisture that occurs over the period of long duration demolition work, resulting in deterioration of effectiveness, can be prevented by gelation and maintaining moisture in the gel with Solution B. The gel can prevent trapped dust and harmful substances from being discharged into the soil, and can prevent them from drying and being released into air. Since dust and harmful contaminants are coated with an alginic gel, accidental ingestion by humans can be prevented. As a result of the above, the systems and methods described herein can prevent release of airborne contaminants, such as asbestos and glass fiber contained in FRP, as well as other contaminants (e.g., heavy metals and organic substances). These contaminants can be prevented from contaminating the environment, and can thereby the gel can prevent adverse effects on humans and other living organisms.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

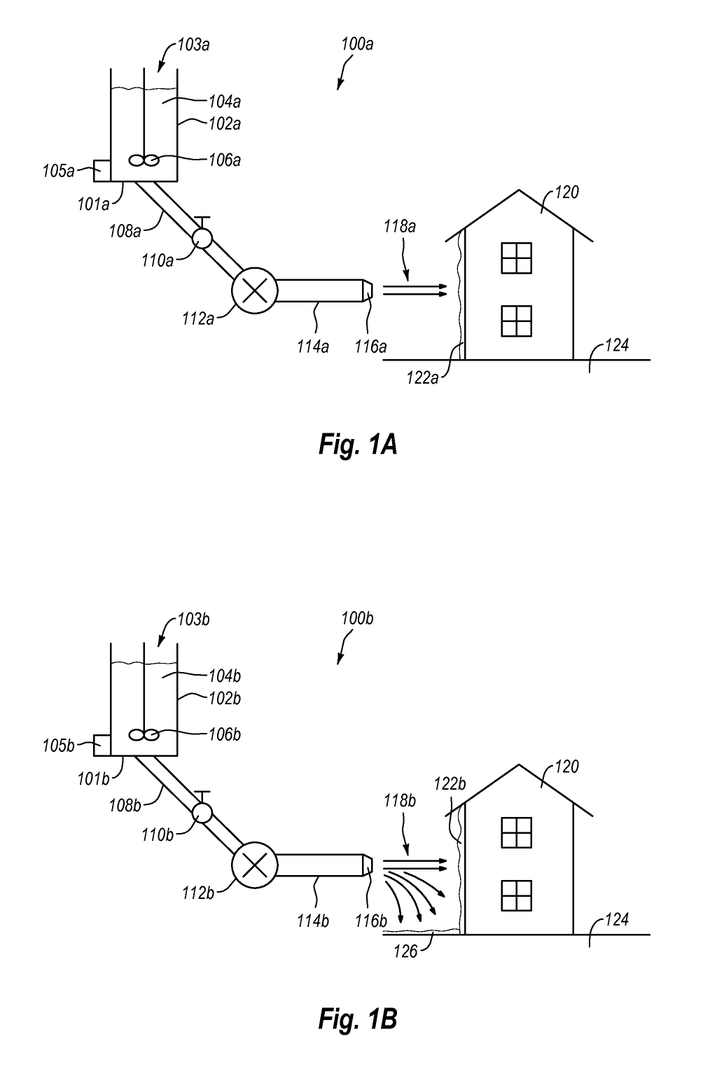

FIGS. 1A-1B show schematic representations of illustrative embodiments of a system for reducing environmental contamination from structure demolition. More specifically, FIGS. 1A-1B show an illustration of an example of a system 100a, 100b for forming a gel 122b on a structure 120. As shown in FIG. 1A, a first system 100a includes a vessel 102a having a first aqueous composition 104a. The first aqueous composition 104a can include an alginic acid or alginate dissolved in water. Optionally, the vessel 102a can include a stirrer 106a or other means for mechanically agitating the first aqueous composition 104a allowing it to maintain a flowable, fluid characteristic. In another option, the vessel 102a can include a heater 105a to heat the first aqueous composition 104a to maintain a flowable, fluid characteristic.

The vessel 102a is shown to be fluidly coupled to a fluid pathway 108a at the bottom 101a of the vessel 102a; however, the fluid pathway 108a may be inserted through a top opening 103a of the vessel 102a so as to be located in the first aqueous composition 104a. Optionally, the fluid pathway 108a can include a valve 110a that can open or close to regulate flow of the first aqueous composition 104a through the fluid pathway 108a.

The fluid pathway 108a can also be fluidly coupled with a pump 112a such that the first aqueous composition 104a can be pumped through a sprayer 114a and out from a nozzle 116a of the sprayer 114a. The sprayer 114a can be mechanical and include the pump 112a as a component thereof. Also, the sprayer 114a can include an adjustable nozzle 116a that can have the spray pattern adjusted from a stream through a mist. The sprayer 114a can be oriented with respect to the structure 120 such that the spray 118a is directed onto the structure 120 to form a coating 122a of the first aqueous composition 104a. Optionally, the first aqueous composition 102a can be sprayed on the ground 124.

Referring to FIG. 1B, a second system 100b includes a second vessel 102b having a second aqueous composition 104b. The second aqueous composition 104b can include a calcium salt dissolved in water. Optionally, the vessel 102b can include a stirrer 106b or other means for mechanically agitating the second aqueous composition 104b allowing it to maintain a flowable, fluid characteristic. In another option, the vessel 102b can include a heater 105b to heat the first aqueous composition 104b to maintain a flowable, fluid characteristic.

The second vessel 102b is shown to be fluidly coupled to a second fluid pathway 108b at the bottom 101b of the second vessel 102b; however, the fluid pathway 108a may be inserted through a top opening 103a of the vessel 102a so as to be located in the second aqueous composition 104b. Optionally, the second fluid pathway 108b can include a second valve 110b that can open or close to regulate flow of the second aqueous composition 104b through the second fluid pathway 108b.

The second fluid pathway 108b can also be fluidly coupled with a second pump 112b such that the second aqueous composition 104b can be pumped through a second sprayer 114b and out from a second nozzle 116b of the second sprayer 114b. The sprayer 114b can be mechanical and include the pump 112b as a component thereof. Also, the sprayer 114b can include an adjustable nozzle 116b that can have the spray pattern adjusted from a stream through a mist. The sprayer 114b can be oriented with respect to the structure 120 such that the second spray 118b is directed onto the structure 120. Also, the sprayer 114b can be oriented so as to be capable of spraying the second aqueous composition 104b into the ground 122 (e.g., sand, soil, rock, plants, grass, etc.) in proximity to the structure 120.

FIG. 1B also shows that the second sprayer 114b can spray 118b the second aqueous composition 104b on the coating of the first aqueous composition 104a previously sprayed on the structure. When the second aqueous composition 104b is sprayed 118b onto the first aqueous composition 104a, gelation occurs to form a gel coating 122b on the structure 120. The gel coating 122b is prepared so as to be capable of capturing and retaining particulate or liquid contaminants that may be present or generated with the structure 120 is demolished, razed, or otherwise deconstructed. The second aqueous composition 104b can be sprayed 118b from time to time onto the gel coating 122b to keep the gel moist and prevent drying. The aqueous composition 104b can also be sprayed 118b on the ground 122 in proximity to the structure 120 so that the gel coating 122 with or without contaminants can remain moist when demolition knocks the structure and/or gel coating 122b to the ground 122. Also, the second aqueous composition 104b can be sprayed 118b on the ground 122 so that any portion of the first aqueous composition 104a that is not gelled can then gel on the ground 122 to form a ground coating 126. The ground coating 126 can also be formed from the gel coating 122b falling to the ground 124 and being moistened. The gel ground coating 126 can also be capable of capturing and retaining contaminants.

At any time, the cell coating 122b and/or ground coating 126 can be collected so that the contaminants trapped and retained therein can be prevented from contaminating the environment. The collection of the gel can be manually with hand tools or with mechanized equipment, such as bulldozers, backhoes, or the like. The collected gel can then be stored or disposed of. Incineration is a suitable process for disposing of the collected gel.

In one option, the first aqueous composition 104a can be sprayed on the ground 124, and then the second aqueous composition 104b can be sprayed onto the first aqueous composition 104a, or vice versa, such that the compositions for a gel on the ground (not shown). The gel on the ground can capture and retain contaminants as described herein.

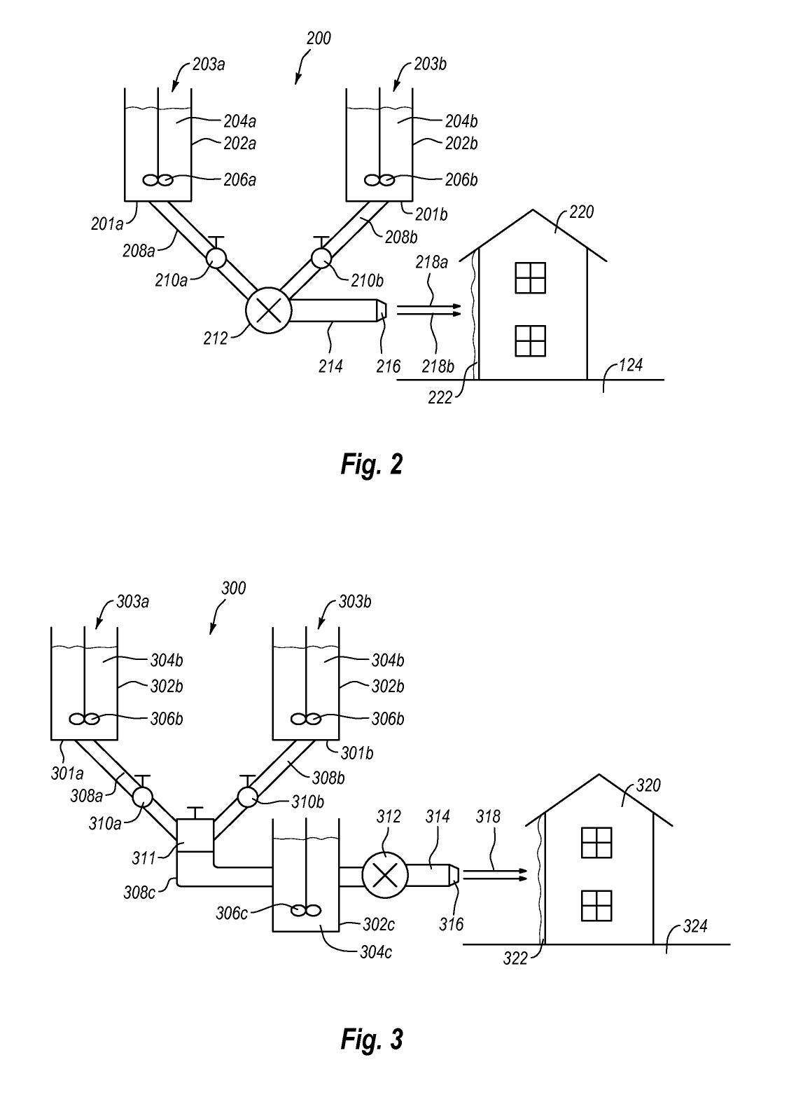

FIG. 2 shows a schematic representation of an illustrative embodiment of a system for reducing environmental contamination from structure demolition. More specifically, FIG. 2 provides an illustration of an example of a system 200 for forming a gel 222 on a structure 220. As shown, a first vessel 202a has a first aqueous composition 204a. The first aqueous composition 204a can include an alginic acid or alginate dissolved in water. Optionally, the first vessel 202a can include a first stirrer 206a or other means for mechanically agitating the first aqueous composition 204a allowing it to maintain a flowable, fluid characteristic. The first vessel 202a is shown to be fluidly coupled to a first fluid pathway 208a at the bottom 201a of the vessel 202a; however, the first fluid pathway 208a may be inserted through a top opening 203a of the vessel 202a so as to be located in the first aqueous composition 204a. Optionally, the first fluid pathway 208a can include a valve 210a that can open or close to regulate flow of the first aqueous composition 204a through the fluid pathway 208a.

Also shown is a second vessel 202b having a second aqueous composition 204b. The second aqueous composition 204b can include calcium salt or ionized calcium dissolved in water. Optionally, the second vessel 202b can include a second stirrer 206b or other means for mechanically agitating the second aqueous composition 204b allowing it to maintain a flowable, fluid characteristic. The second vessel 202b is shown to be fluidly coupled to a second fluid pathway 208b at the bottom 201b of the second vessel 202b; however, the second fluid pathway 208b may be inserted through a top opening 203b of the vessel 202b so as to be located in the second aqueous composition 204b. Optionally, the second fluid pathway 208b can include a second valve 210b that can open or close to regulate flow of the second aqueous composition 204b through the second fluid pathway 208b.

The fluid pathways 208a, 208b can also be fluidly coupled with a pump 212 such that the first aqueous composition 204a can be pumped through a sprayer 214 and out from a nozzle 216 of the sprayer 214. The sprayer 214 can be mechanical and include the pump 212 as a component thereof. Also, the sprayer 214 can include an adjustable nozzle 216 that can have the spray pattern adjusted from a stream through a mist. The pump 212 can be fluidly coupled with the first and second pathways 208a, 208b, and the valves 210a, 210b can regulate which composition (e.g., the first aqueous composition 204a or second aqueous composition 204b) is sprayed through the sprayer 214. As such, the sprayer 214 can spray the first aqueous composition 204a and then the second aqueous composition 204b, or vice versa, as well as alternating. The sprayer 214 can be oriented with respect to a structure 220 such that the spray 218a of the first aqueous composition 204a or the spray 218b of the second aqueous composition is directed onto the structure 220 to form a gel coating 222. The gel coating 222 is formed from combining the first aqueous composition with the second aqueous composition, and thereby either composition can be sprayed onto the structure first and then receive the other composition for gelation.

FIG. 3 shows a schematic representation of an illustrative embodiment of a system for reducing environmental contamination from structure demolition. More specifically, FIG. 3 provides an illustration of an example of another system 300 for forming a gel 322 on a structure 320. As shown, a first vessel 302a has a first aqueous composition 304a. The first aqueous composition 304a can include an alginic acid or alginate dissolved in water. Optionally, the first vessel 302a can include a first stirrer 306a or other means for mechanically agitating the first aqueous composition 304a allowing it to maintain a flowable, fluid characteristic. The first vessel 302a is shown to be fluidly coupled to a first fluid pathway 308a at the bottom 301a of the vessel 302a; however, the first fluid pathway 308a may be inserted through a top opening 303a of the vessel 302a so as to be located in the first aqueous composition 304a. The first fluid pathway 308a can be coupled to a first valve 310a that can open or close to regulate flow of the first aqueous composition 304a from the fluid pathway 308a.

Also shown is a second vessel 302b having a second aqueous composition 304b. The second aqueous composition 304b can include calcium salt or ionized calcium dissolved in water. Optionally, the second vessel 302b can include a second stirrer 306b or other means for mechanically agitating the second aqueous composition 304b allowing it to maintain a flowable, fluid characteristic. The second vessel 302b is shown to be fluidly coupled to a second fluid pathway 308b at the bottom 301b of the second vessel 302b; however, the second fluid pathway 308b may be inserted through a top opening 303b of the vessel 302b so as to be located in the second aqueous composition 304b. The second fluid pathway 308b can be coupled to a second valve 310b that can open or close to regulate flow of the second aqueous composition 304b from the second fluid pathway 208b.

The fluid pathways 308a, 308b are shown to be coupled to a junction 311 that allows for the compositions flowing into the junction 311 to be combined and then flow through a third fluid pathway 308c into a third vessel 302c. The third vessel 302c can receive the combination of the first and second aqueous compositions 304a, 304b which are then mixed to form a gelling composition 304c. Optionally, the third vessel 302c can include a third stirrer 306c that can be used to keep the gelling composition 304c in a fluid format so that it can be applied to a structure 320. As such, the third vessel 302c can be fluidly coupled to a pump 312 such that the gelling composition 302c can be pumped through a sprayer 314 and out from a nozzle 316 of the sprayer 314. The sprayer 314 can be mechanical and include the pump 312 as a component thereof. Also, the sprayer 314 can include an adjustable nozzle 316 that can have the spray pattern adjusted from a stream through a mist that can spray a more viscous fluid, such as the gelling composition 302c. The sprayer 314 can then spray 318 the gelling composition 302c onto the structure 320 such that a gel coating 322 is formed thereon. Optionally, the sprayer 314 can spray the gelling composition 302c on the ground 324.

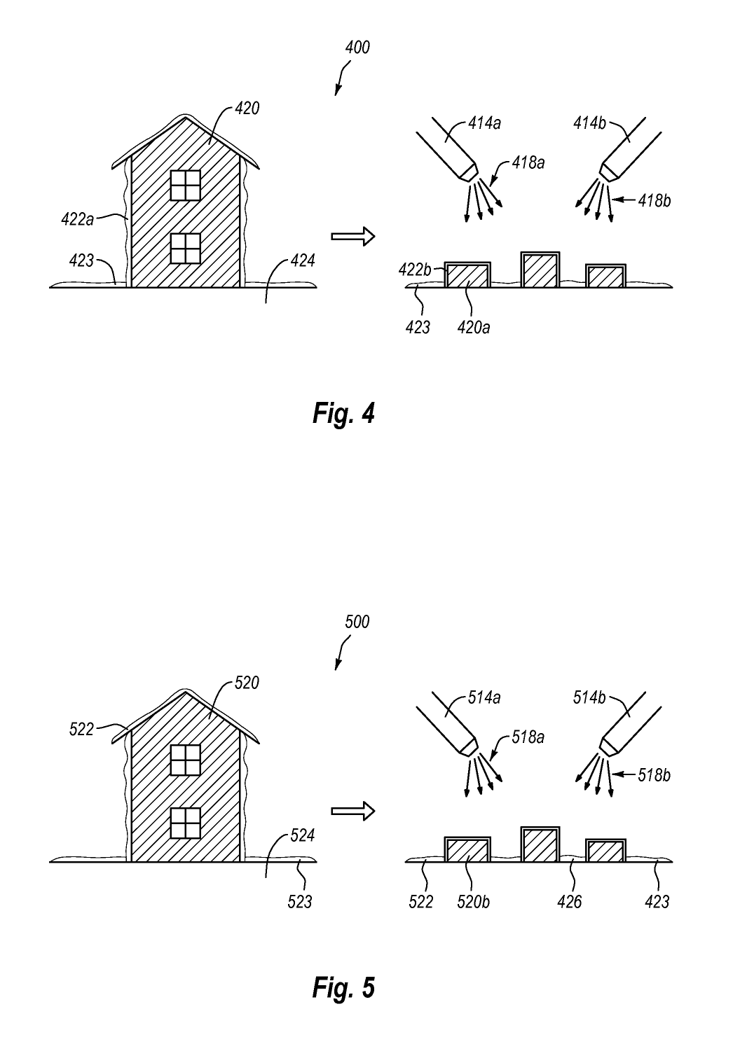

FIG. 4 shows a schematic representation of an illustrative embodiment of a process 400 for reducing environmental contamination from structure demolition. The process 400 includes coating a structure 420 with an aqueous alginic composition 422a (e.g., alginic acid and/or alginate). The ground 424 proximal to the structure 420 is coated with a calcium composition 423. Optionally, after the structure 420 is demolished into rubble 420a, the rubble 420a can be coated again with the aqueous alginic composition 422a by spraying 418a the alginic composition 422a onto the rubble 420a. Whether or not the rubble 420a is sprayed 418a again with the alginic composition 423, the rubble 420a is sprayed with the calcium composition 423 so that any alginic composition is gelled into a gel coating 422b covering the rubble 420a. Also, when rubble 420a contacts the ground, the gel can form from the alginic composition 422a contacting the calcium composition 423.

FIG. 5 shows a schematic representation of an illustrative embodiment of a process 500 for reducing environmental contamination from structure demolition. The process 500 includes coating a structure 520 with a gel coating 522 formed from an alginic composition and a calcium composition. The ground 524 proximal to the structure 520 can optionally be coated with a calcium composition 523. Optionally, after the structure 520 is demolished into rubble 520a, the rubble 520a can be coated again with the alginic composition 522a by spraying 518a the alginic composition onto the rubble 520a. Whether or not the rubble 520a is sprayed 518a again with the alginic composition, the rubble 520a is sprayed with the calcium composition 523 so that any alginic composition is gelled into a gel coating 522 covering the rubble 520a. Also, when rubble 520a contacts the ground, the gel can form from the alginic composition contacting the calcium composition 423. Also, the ground 524 having the calcium composition 423 coating can receive the spray 518a of the alginic composition so as to form a gel ground coating 526. The ground coating 526 can also be formed from the gel coating 522 falling to the ground 524 and being moistened. The gel ground coating 526 can also be capable of capturing and retaining contaminants.

In further discussion of the systems and methods described herein, a system for reducing environmental contamination from construction/demolition activities can include: a fluid first aqueous composition having an alginic acid or alginate dissolved in water; and a fluid second aqueous composition having a calcium salt dissolved in water. The alginate can include an alginate salt having a counter ion with a +1 or +2 charge. The counter ion can include sodium or calcium, where the first aqueous composition includes more sodium than calcium counter ion. However, other counter ions with a +1 or +2 charge may be used. Optionally, the first aqueous composition can include a calcium alginate, where the calcium alginate is present in an amount less than sodium alginate. The system can be modified in accordance with descriptions of the methods below.

The compositions of the system may include one or more additional components that modulate the properties of the compositions, such as modulate the viscosity. The system can include the fluid first and/or second aqueous compositions having a polysaccharide and/or surfactant in an amount less than the alginate. As such, the compositions can include one or more of the following in an amount less than the alginate: calcium alginate; gum Arabic; carrageenan; fucoidan; agarose; pectin; alkylbenzene sulfonate; alkyl trimethyl ammonium salt; alkylcarboxylic betaine; saponin; F-gitonin; surfactant phospholipids; or surfactant polypeptides.

The compositions of the system can be configured to be in a format suitable for application to structures, the ground, or environment in general. For example, at least one of the first aqueous composition or second aqueous composition can be configured to be sprayable, brushable, rollable, or any of application form. In one aspect, the system can include one or more sprayers, brushes, rollers, or any other applicator. In one aspect, the system can include the composition in the applicator, such as in a container of a sprayer.

In one embodiment, the first aqueous composition can have a viscosity from about 0.1 cp to about 1×10⁶ cpor from about 100 cp to about 800 cp. For example, a beneficial viscosity range can be from about 50 cp to about 500 cp. An example of a low viscosity can be 0.089 cp.

In one embodiment, the compositions of the system can be devoid of a calcium chelator or other entity that binds calcium such that the calcium aggregation the alginic acid or alginate is inhibited. The compositions may also be devoid of any substance that binds calcium and inhibits the calcium from interacting with the alginic substance. Calcium chelators or binding substances can bind calcium and inhibit the alginic substance from gelling.

In one embodiment, a method for reducing environmental contamination from construction/demolition activities can include: providing a system as described herein; applying the first aqueous composition (i.e., Solution A) to an object or structure included in a construction/demolition site involved with construction/demolition activities; applying the second aqueous composition (i.e., Solution B) to the first composition on the object or structure or directly to the object or structure such that the alginic acid or alginate undergoes gelation into a gel upon exposure to ionized calcium in the second aqueous composition; and conducting construction or demolition activities with or around the object or structure (e.g., demolishing the structure) such that the gel captures contaminants (e.g., particles or liquids) and inhibits environmental contamination from the contaminants that are generated or released from the construction/demolition activities. The compositions of the system can be pre-prepared or prepared just prior to use. The application of the compositions can be performed by various application techniques for applying liquids to surfaces, such as those described herein. The second aqueous composition can be applied before, during, or after applying the first aqueous composition. Aspects of other method embodiments can also be performed with regard to this method embodiment.

In one aspect, the method can include applying the first and/or second aqueous composition around the structure. This can include applying the compositions to the ground, soil, dirt, sand, plants, trees, rocks, other objects or structures, or anything else in an activity site having construction and/or demolition activities. In another aspect, the method can include applying the first and/or second aqueous composition to soil around the structure. In another aspect, the method can include applying the first and/or second aqueous composition to a construction/demolition site having the object or structure. All or a portion of the construction/demolition site can receive either or both of the compositions can have gel formed thereon.

In one embodiment, a method for reducing environmental contamination from construction/demolition activities can include: providing or preparing a system as described herein; spraying the first aqueous composition (e.g., Solution A) having viscosity to an object or structure in a construction/demolition area; spraying the second aqueous composition (e.g., Solution B) to the first composition on the object or structure such that the alginic acid or alginate undergoes gelation into a gel on the object or structure; and performing construction or demolition activities at the construction demolition area (e.g., demolishing the structure) that produces such that the gel captures particles and inhibits the particles from becoming airborne and blowing from the construction/demolition area. Aspects of other method embodiments can also be performed with regard to this method embodiment.

In one embodiment, a method for reducing environmental contamination from construction/demolition activities can include: providing a fluid aqueous composition having an alginic acid or alginate dissolved in water; combining ionized calcium to the alginic acid or alginate; applying the aqueous composition to a structure to be demolished such that the alginic acid or alginate undergoes gelation into a gel with the ionized calcium; and performing construction/demolition activities with regard to the structure such that particles are formed from the activities and the gel captures the particles and inhibits environmental contamination from the particles. The combining of the ionized calcium with the aqueous composition can occur before, during, or after applying the first aqueous composition to the structure. This method can also include applying the aqueous composition, water, and/or ionized calcium around the structure, to soil, to soil around the structure, to a demolition site having the structure, or other area near the demolition. The size of the area that receives the compositions can be larger for large structures and smaller for small structures. Aspects of other method embodiments can also be performed with regard to this method embodiment.

In one embodiment, yet another method for reducing environmental contamination from structure demolition can include: providing a system as described herein; applying the first aqueous composition to a structure to be demolished; applying the second aqueous composition to ground or soil around structure; and demolishing the structure such that first aqueous composition contacts the second aqueous composition and forms a gel which captures particles and inhibits environmental contamination from the particles. The gel is formed on the ground or soil and is capable of capturing dust, solid, and liquid contaminants. Aspects of other method embodiments can also be performed with regard to this method embodiment.

In one embodiment, another method for reducing environmental contamination from structure demolition can include: providing a system as described herein; applying the first aqueous composition to a demolition site; and applying the second aqueous composition to the first composition on the demolition site such that the alginic acid or alginate undergoes gelation into a gel that captures particles and inhibits environmental contamination from the particles. Aspects of other method embodiments can also be performed with regard to this method embodiment.

In one embodiment, another method for reducing environmental contamination from structure demolition can include: providing a system as described herein; applying the first aqueous composition to demolition site; applying the second aqueous composition to the first composition on the demolition site such that the alginic acid or alginate undergoes gelation into a gel that captures particles and inhibits environmental contamination from the particles. Aspects of other method embodiments can also be performed with regard to this method embodiment.

In one embodiment, another method for reducing environmental contamination from structure demolition can include: providing a system as described herein; applying the first aqueous composition to contaminants; and applying the second aqueous composition to the first composition on the contaminants such that the alginic acid or alginate undergoes gelation into a gel that captures the contaminants and inhibits environmental contamination from the contaminants. Aspects of other method embodiments can also be performed with regard to this method embodiment.

In one embodiment, the alginic acid or alginate in the first aqueous composition can be from about 0.5% to about 40% by weight, from about 1% to about 20% by weight, or from about 2 to about 10% by weight of the first aqueous composition (i.e., Solution A). In one aspect, the alginic acid or alginate can include sodium alginate in the first aqueous composition from about 0.5% to about 40% by weight from about 1% to about 20%, or from about 2% to about 10% by weight of the first aqueous composition. When included, calcium alginate in the first aqueous composition can be in an amount from about 0.001% to about 5% by weight or in an amount less than about 1% by weight of the first aqueous composition. The alginic acid or alginate can have a molecular weight from about 10,000 to about 600,000 Da, from about 50,000 to about 300,000 Da, or from about 75,000 to about 150,000 Da.

In one embodiment, the second aqueous composition can include calcium or calcium salt or other ionized calcium from about 0.01% to about 20% by weight, from about 0.1% to about 10% by weight, from about 1% to about 5% by weight, or at about 1% by weight by weight of the second aqueous composition. In one option, the second aqueous composition can include ionized calcium from about 0.01% to about 20% by weight, from about 0.1% to about 10% by weight, from about 1% to about 5% by weight, or at about 1% by weight. In one option, the calcium salt of the second aqueous composition can include calcium alginate or calcium lactate.

In one embodiment, the fluid first and/or second aqueous compositions can include a polysaccharide and/or surfactant in an amount less than the alginate. In one aspect, the fluid first and/or second aqueous compositions can include one or more of the following in an amount less than the alginate: calcium alginate; gum Arabic; carrageenan; fucoidan; agarose; pectin; alkylbenzene sulfonate; alkyl trimethyl ammonium salt; alkylcarboxylic betaine; saponin; F-gitonin; surfactant phospholipids; or surfactant polypeptides.

In one embodiment, at least one of the first aqueous composition or second aqueous composition is configured to be sprayable, brushable, rollable, or any of application form. In one aspect, the system can include one or more sprayers, brushes, rollers, or any other applicator. In one aspect, the system can include the composition in the applicator, such as in a container of a sprayer.

In one embodiment, the method can include covering at least a portion of the structure during gelation. The covering can optionally be a water-impermeable covering. For example, the covering can be a plastic covering.

In one embodiment, the method can include combining the first aqueous composition and the second aqueous composition before application to the structure. The combining of the compositions and application can be before gelation inhibits application to the structure.

The first and/or second compositions can be applied in a variety of ways. In one aspect, application of the first aqueous composition is by spraying, rolling, or brushing. In one aspect, application of the second aqueous composition is by spraying, rolling, or brushing. In another aspect, the first aqueous composition and/or second aqueous composition can be maintained as a fluid before application to the structure or surrounding areas. The compositions can be maintained as fluids by heat or mechanical agitation. The temperature can be sufficient to fluidize the composition or maintain fluidic properties. The mechanical agitation can be by stirring or other mechanical manipulation of the compositions.

In one embodiment, the method can include at least partially coating the structure with the gel. Alternatively, the method can include substantially coating the structure with the gel.

In one embodiment, the method can include maintaining the gel to be moist during the demolition. Maintaining gel moistness can include applying water to the gel to maintain moistness during the demolition. Also, the second aqueous composition can be applied to the gel to maintain moistness during or after the demolition.

In one embodiment, the method can include collecting the gel after the demolition. The collection can be conducted manually with hand tool or with mechanized equipment. The collected gel that includes the contaminants can be stored or destroyed. The gel can be destroyed by burning. The containment or destruction of the gel can be useful to prevent environmental contamination from particulates in the gel.

In one embodiment, the demolition can be conducted within 8 hours of gelation, within 4 hours of gelation, or within 2 hour of gelation. It can be beneficial to perform the demolition as soon as possible after gelation or combining the composition such that gelation has initiated. Optionally, the demolition can be conducted while the gel and structure are covered in plastic.

In one embodiment, the combining of the ionized calcium with the aqueous composition can occur before, during, or after applying the first aqueous composition to the structure. This method can also include applying the aqueous composition, water, and/or ionized calcium around the structure, to soil, to soil around the structure, to a demolition site having the structure, or other area near the demolition. The size of the area that receives the compositions can be larger for large structures and smaller for small structures. Aspects of other method embodiments can also be performed with regard to this method embodiment.

In one example, Solution A can be prepared by adding sodium alginate to cold water and stirring. Then, a small amount of calcium alginate is added to give the composition thixotropic properties. While continuously stirring to keep the viscosity of Solution A low, a pump is used to flow Solution A through a tube to a sprayer. The sprayer can be a pressurized sprayer that sprays Solution A onto a structure or object as described herein. When sufficient time has elapsed, Solution A becomes more viscous again and securely adheres to the surface of the structure. It does not take long for Solution A to adhere to the surface, which allows for application from vertical to horizontal surfaces. Also, the relative amount of alginic substance and calcium in Solution A can be modulated for viscosity suitable to adhere to various surfaces ranging from vertical to horizontal. In the case of demolition work, after application to the structure an aqueous solution containing calcium salt (e.g., Solution B) is sprayed onto the surface having Solution A. This promotes gelation of the compositions on the surface, thereby preventing the demolition work from releasing contaminants into the environment as the gel can capture and retain such contaminants.

In another example, Solution A can be applied to a structure, while the aqueous solution containing calcium salt (e.g., Solution B) is applied to the ground or environment surrounding the structure prior to demolition work. During demolition of the structure, debris having Solution A falls to the ground and contacts Solution B. The debris having Solution A that fell onto the ground together with the demolition materials gels by reaction with Solution B on the ground. The gelation forms a gel that captures and retains contaminants. As such, the gel can prevent dust and waste liquid contaminants generated as a result of the demolition work, from draining into the soil and spreading into waterways.

Alternatively, during or after demolition work, Solution B can be applied to the structure to be demolished, and when Solution B comes into contact with Solution A a gel spontaneously and quickly forms. After demolition work, the gel together with the demolition materials and contaminants can be collected and disposed of by incineration or other disposal methods.

In one embodiment, the application of Solutions A and B can be directly on contaminants so that a gel forms on and captures the contaminants. This can include forming a gel as described herein on contaminants that are not associated with construction and/or demolition activities. The gel can be formed on heavy metals, organics, and toxic particles to prevent the risk of adverse effects on humans in the event of airborne release or accidental consumption of the contaminants. For example, a contaminated environment can receive the gel as described herein so that contaminants are captured and retained in the gel. The gel can then be collected and removed as part of a cleanup effort.

The aqueous composition having the alginic substance (Solution A) can be prepared with a variety of concentrations of alginic substance as described herein. Generally, the composition can be prepared by dissolving sodium alginate in cold or warm water. In order to impart thixotropic properties, a small amount of calcium alginate is added to the composition. The calcium content is a small amount, but enough to impart thixotropy without inducing significant gelation. One example can include 1 wt % sodium alginate aqueous solution, however, the amount of sodium alginate can range from about 1-20 wt %. The amount of calcium added can modulate the viscosity between about 1 to about 800 cP, from about 10 to about 600 cP, or from about 100 to about 500 cP.

Examples can include: an alginic substance from Kimizu Chemicals having sodium alginate with a viscosity of a 1% solution being about 20-50 cps; an alginic substance from Kimizu Chemicals having sodium alginate with a viscosity of a 10% solution being 500 cps; an alginic substance from Wako Pure Chemicals having sodium alginate with a viscosity of a 1% solution being 20 cps; and an alginic substance from Kibun Food Chemipha referred to as Dack alginic acid (DA-20) at a 1% solution having a viscosity of 20 cps.

The aqueous composition having calcium (Solution B) can be prepared by dissolving calcium salt in cold or warm water. In one example, Solution B can be a 1 wt % calcium chloride aqueous solution, where around 1% by weight of calcium chloride or calcium lactate is appropriate. The composition can include 0.1 M (mol) CaCl₂.

The compositions can be applied to a surface in order to produce a gel. The gel can range from about 0.5 mm to about 10 mm, or from about 1 mm to about 5 mm, or from about 2 mm to about 3 mm. A surface of 1 square meter can have a 3 mm gel coating from 3 liters of Solution A. Solution B is added at 3 liters or more.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A system for reducing environmental contamination from structure demolition, the system comprising:
a fluid first aqueous composition having an alginic acid or alginate dissolved in water;
a fluid second aqueous composition having a calcium salt dissolved in water; and
one or more sprayers.

2. (canceled)

3. The system of claim 1, wherein the alginate includes an alginate salt having a counter ion that includes sodium or calcium.

4. (canceled)

5. The system of claim 3, wherein the first aqueous composition includes a calcium alginate, wherein the calcium alginate is present in an amount less than sodium alginate.

6. The system of claim 5, wherein the alginic acid or alginate in the first aqueous composition is from about 0.5% to about 40% by weight.

7. (canceled)

8. (canceled)

9. (canceled)

10. The system of claim 5, wherein calcium alginate in the first aqueous composition is in an amount from about 0.001% to about 5% by weight.

11-19. (canceled)

20. The system of claim 1, wherein the calcium salt of the second aqueous composition includes calcium lactate.

21. (canceled)

22. (canceled)

23. (canceled)

24. The system of claim 1, wherein the fluid first and/or second aqueous compositions include one or more of the following in an amount less than the alginate:
calcium alginate;
gum Arabic;
carrageenan;
fucoidan;
agarose;
pectin;
alkylbenzene sulfonate;
alkyl trimethyl ammonium salt;
alkylcarboxylic betaine;
saponin;
F-gitonin;
surfactant phospholipids; or
surfactant polypeptides.

25. (canceled)

26. (canceled)

27. The system of claim 1, wherein at least one of the first aqueous composition or second aqueous composition is in a sprayer.

28. The system of claim 1, devoid of a calcium chelator.

29. (canceled)

30. (canceled)

31. A method for reducing environmental contamination from structure demolition, the method comprising:
applying a fluid first aqueous composition to a structure to be demolished, the fluid first aqueous composition having an alginic acid or alginate dissolved in water;
applying a fluid second aqueous composition to the first composition on the structure such that the alginic acid or alginate undergoes gelation into a gel, the fluid second aqueous composition having a calcium salt dissolved in water; and
demolishing the structure such that the gel captures particles and inhibits environmental contamination from the particles.

32. The method of claim 31, wherein applying the second aqueous composition occurs before, during, or after applying the first aqueous composition.

33. The method of claim 32, further comprising one or more of the following:
applying the first and/or second aqueous composition around the structure;
applying the first and/or second aqueous composition to soil around the structure;
applying the first and/or second aqueous composition to a demolition site having the structure;
covering at least a portion of the structure during gelation with a water-impermeable covering;
preparing the first aqueous composition and/or the second aqueous composition; or combining the first aqueous composition and the second aqueous composition before application to the structure.

34-43. (canceled)

44. The method of claim 33, further comprising maintaining the first aqueous composition to be fluid before application to the structure.

45-48. (canceled)

49. The method of claim 31, further comprising maintaining the gel to be moist during the demolition.

50. (canceled)

51. (canceled)

52. The method of claim 31, further comprising:
collecting the gel having particulates therein after the demolition; and
disposing of the collected gel so as to prevent environmental contamination from particulates in the gel.

53-57. (canceled)

58. A method for reducing environmental contamination from structure demolition, the method comprising:
providing a fluid aqueous composition having an alginic acid or alginate dissolved in water;
combining ionized calcium to the alginic acid or alginate;
applying the aqueous composition to a structure to be demolished such that the alginic acid or alginate undergoes gelation into a gel; and
demolishing the structure such that the gel captures particles and inhibits environmental contamination from the particles.

59. The method of claim 58, wherein combining the ionized calcium with the aqueous composition occurs before, during, or after applying the first aqueous composition to the structure.

60. (canceled)

61. The method of claim 59, further comprising one or more of the following:
applying the aqueous composition, water, and/or ionized calcium to soil around the structure;
applying the aqueous composition, water, and/or ionized calcium to a demolition site having the structure;
covering at least a portion of the structure during gelation;
preparing the aqueous composition; or
maintaining the aqueous composition to be fluid before application to the structure.

62-73. (canceled)

74. The method of claim 61, further comprising one or more of the following:
applying water to the gel to maintain moistness during the demolition;
applying an aqueous composition having ionized calcium to the gel to maintain moistness during the demolition;
collecting the gel having the particles after the demolition;
disposing of the gel having the particles so as to prevent environmental contamination from particulates in the gel.

75-86. (canceled)

87. The system of claim 1, wherein the calcium salt of the second aqueous composition includes calcium alginate.
